(19) United States
(12) Patent Application Publication
(10) Pub. No.: US 2020/0322923 A1
(43) Pub. Date: Oct. 8, 2020

(54) USER EQUIPMENT AND TRANSMISSION METHOD

(71) Applicant: NTT DOCOMO, INC.

(72) Inventors: Shimpei Yasukawa, Tokyo (JP); Satoshi Nagata, Tokyo (JP); Qun Zhao, Beijing (CN); Liu Liu, Beijing (CN); Anxin Li, Beijing (CN); Huiling Jiang, Beijing (CN)

(73) Assignees: NTT DOCOMO, INC., Tokyo (JP); NTT DOCOMO, INC., Tokyo (JP)

(21) Appl. No.: 16/088,360

(22) PCT Filed: Mar. 16, 2017
(86) PCT No.: PCT/JP2017/010621

§ 371 Date: Sep. 25, 2018

(30) Foreign Application Priority Data
Mar. 31, 2016 (JP) 2016-073454

(51) Int. Cl. H04W 72/02; H04W 72/04

(52) U.S. Cl. CPC H04W 72/02; H04W 92/18; H04W 72/0406

(57) ABSTRACT

Provided is user equipment of a radio communication system that supports D2D communication, the user equipment including a selector that selects a plurality of control information resources for repeatedly transmitting control information from a control information resource pool and that selects a plurality of data resources for repeatedly transmitting data from a data transmission resource pool; and a transmitter that repeatedly transmits the control information including information that specifies the data resources using the control information resources and repeatedly transmits the data using the data resources, wherein the selector selects the control information resources and the data resources so that a control information resource for transmitting the control information for a first time among the control information resources and a data resource for transmitting the data for a first time among the data resources are in a same subframe.

### TECHNICAL FIELD

The present invention relates to user equipment and a transmission method.

### BACKGROUND ART

As for Long Term Evolution (LTE) and LTE successor systems (which is also referred to, for example, as LTE Advanced (LTE-A), 4G, Future Radio Access (FRA), etc.), a Device to Device (D2D) technique has been studied which is for allowing units of user equipment to perform direct communication without intervention of a radio base station (for example, Non-Patent Document 1).

D2D reduces the traffic between units of user equipment and a base station, and allows unit of user equipment to communicate even when the base station becomes unable to communicate at a time of a disaster, etc.

D2D is broadly classified into D2D discovery for discovering another communicable user equipment and D2D communication (also referred to as D2D direct communication or terminal-to-terminal direct communication) for allowing direct communication to be performed between units of user equipment. In the following description, D2D communication and D2D discovery are referred to simply as D2D when both are not particularly distinguished from each other. Moreover, signals transmitted and received by D2D are referred to as D2D signals.

In 3rd Generation Partnership Project (3GPP), it has been studied to achieve V2X by extending the D2D function. Here, V2X is a part of Intelligent Transport Systems (ITS), and as illustrated in FIG. 1, is a generic term of Vehicle to Vehicle (V2V) meaning a form of communication performed between vehicles, Vehicle to Infrastructure (V2I) meaning a form of communication performed between a vehicle and a road-side unit (RSU: Road-Side Unit) provided on the roadside, Vehicle to Nomadic device (V2N) meaning a form of communication performed between a vehicle and a mobile terminal of a driver, and Vehicle to Pedestrian (V2P) meaning a form of communication performed between a vehicle and a mobile terminal of a pedestrian.

### PRIOR ART DOCUMENT

### Non-Patent Document

Non-Patent Document 1: “Key drivers for LTE success: Services Evolution”, September 2011, 3GPP, Internet URL: http://www.3gpp.org/ftp/Information/presentations/presentations_2011/2011_09_LTE_Asia/2011_LTE-Asia_3GPP_Service_evolution.pdf
Non-Patent Document 2: 3GPP TS 36.300 V13.2.0 (2015-12)
Non-Patent Document 3: 3GPP TS 36.213 V12.8.0 (2015-12)

### SUMMARY OF THE INVENTION

### Problem to be Solved by the Invention

In D2D, a data resource pool which is a range of radio resources for transmitting data and a control information resource pool which is a range of radio resources for transmitting control information (SCI: Sidelink Control Information) are periodically configured in a time-multiplexed manner. The period is referred to as a PSCCH period (Physical Sidelink Control Channel Period) and the period is defined to be greater than or equal to 40 ms.

A transmission-side user equipment transmits control information (SCI) using a radio resource selected from the control information resource pool and transmits data using a radio resource selected from the data resource pool. The control information includes information indicating the location, etc., of the radio resource selected from the data resource pool. Accordingly, a timing at which the transmission-side user equipment can transmit data is influenced by the length of the PSCCH period and the configuration of the control information/data resource pool.

In current 3GPP, various resource pool configurations have been studied mainly for V2V communication, so as to allow the timings to be flexibly controlled at which control information and data can be transmitted. As an example, as illustrated in FIG. 2, a resource pool configuration in which a control information resource pool and a data resource pool are frequency-multiplexed is discussed.

Rel-12 D2D specifies that the SCI is repeatedly transmitted twice, which includes the first time, in accordance with a predetermined resource selection method (hopping pattern) in frequency and time directions. A reception-side user equipment can enhance reception quality by executing combining reception of two items of SCI. Similarly, it is defined that data is repeatedly transmitted four times including the first time according to the same resource selection method (hopping pattern) as that of the Physical Uplink Shared Channel (PUSCH).

However, when a resource pool configuration is adopted in which a control information resource pool and a data resource pool are frequency-multiplexed as illustrated in FIG. 2, it may be difficult to select resources appropriately using the resource selection method (hopping pattern) defined by the conventional Rel-12 D2D. Moreover, assuming that V2X is one kind of D2D, the above-mentioned problems can occur in D2D in general.

The disclosed technique has been developed in view of the above-described circumstance, and an object is to provide a technique for allowing more appropriate D2D communication to be performed when a resource pool configuration is adopted in which a control information resource pool and a data resource pool are frequency-multiplexed.

### Means for Solving the Problem

User equipment according to the disclosed technology is user equipment of a radio communication system that supports D2D communication, the user equipment including a selector that selects a plurality of control information resources for repeatedly transmitting control information from a control information resource pool and that selects a plurality of data resources for repeatedly transmitting data from a data transmission resource pool; and a transmitter that repeatedly transmits the control information including information that specifies the plurality of data resources using the plurality of control information resources and repeatedly transmits the data using the plurality of data resources, wherein the selector selects the plurality of control information resources and the plurality of data resources so that a control information resource for transmitting the control information for a first time among the plurality of control information resources and a data resource for transmitting the data for a first time among the plurality of data resources are in a same subframe.

### Advantage of the Invention

4) According to the disclosed technique, there is provided a technique for allowing more appropriate D2D communication to be performed when a resource pool configuration is adopted in which a control information resource pool and a data resource pool are frequency-multiplexed.

### BRIEF DESCRIPTION OF DRAWINGS

FIG. 1 is a diagram illustrating V2X;

FIG. 2 is a diagram illustrating a resource pool configuration;

FIG. 3A is a diagram illustrating D2D;

FIG. 3B is a diagram illustrating D2D;

FIG. 4 is a diagram illustrating a MAC PDU used in D2D communication;

FIG. 5 is a diagram illustrating a format of a SL-SCH subheader;

FIG. 6 is a diagram illustrating an example of a channel structure used in D2D;

FIG. 7A is a diagram illustrating an example of a configuration of PSDCH;

FIG. 7B is a diagram illustrating an example of a configuration of PSDCH;

FIG. 8A is a diagram illustrating an example of a configuration of PSCCH and PSSCH;

FIG. 8B is a diagram illustrating an example of a configuration of PSCCH and PSSCH FIG. 9A is a diagram illustrating a resource pool configuration;

FIG. 9B is a diagram illustrating a resource pool configuration;

FIG. 10 is a diagram illustrating an example of a configuration of a wireless communication system according to an embodiment;

FIG. 11 is a diagram illustrating a SCI and data repeat transmission method;

FIG. 12 is a diagram illustrating a method (version 1) of selecting a resource location for transmitting SCI and data for the first time;

FIG. 13 is a diagram illustrating a method (version 2) of selecting a resource location for transmitting SCI and data for the first time;

FIG. 14 is a diagram illustrating a method (version 3) of selecting a resource location for transmitting SCI and data for the first time;

FIG. 15 is a diagram illustrating a method (version 1) of selecting a resource location for transmitting data for the second and subsequent times;

FIG. 16 is a diagram illustrating a method (version 2) of selecting a resource location for transmitting data for the second and subsequent times;

FIG. 17A is a diagram illustrating a method of selecting a resource location for repeatedly transmitting SCI;

FIG. 17B is a diagram illustrating a method of selecting a resource location for repeatedly transmitting SCI;

FIG. 18 is a diagram illustrating a case in which data is repeatedly transmitted across a PSCCH period;

FIG. 19 is a diagram illustrating an example of a functional configuration of user equipment according to an embodiment;

FIG. 20 is a diagram illustrating an example of a functional configuration of a base station according to an embodiment;

FIG. 21 is a diagram illustrating an example of a hardware configuration of user equipment according to an embodiment; and

FIG. 22 is a diagram illustrating an example of a hardware configuration of a base station according to an embodiment.

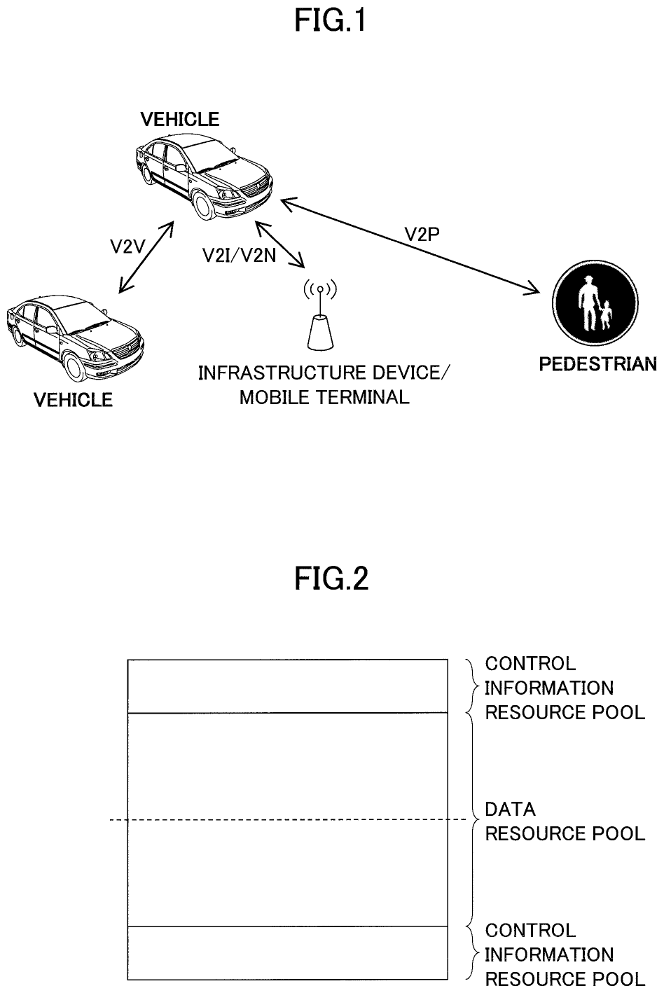

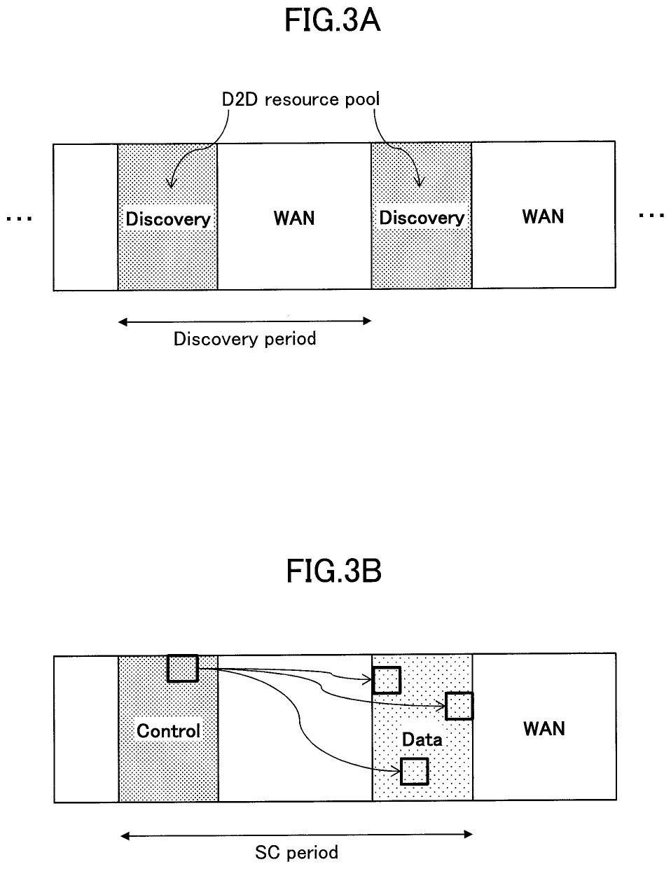

### EMBODIMENTS OF THE INVENTION

Embodiment of the invention are described below by referring to the drawings. The embodiment described below is merely an example, and an embodiment to which the invention is applied is not limited to the following embodiment. For example, although a wireless communication system according to the present embodiment is a system of a scheme compatible with LTE, the invention is not limited to LTE but can be applied to any other schemes. Note that, in this specification and the scope of the claims, “LTE” is used in broad meaning including, not only a communication scheme corresponding to 3GPP Release 8 or 9, but also 3GPP Release 10, 11, 12, or 13, or the fifth generation communication scheme corresponding to on and after 3GPP Release 14.

Although the present embodiment is mainly directed to V2X, the technique according to the present embodiment is not limited to V2X but can be broadly applied to general D2D. Moreover, “D2D” is meant to include V2X.

“D2D” is used in broad meaning to include, not only a processing procedure in which D2D signals are transmitted and received between units of user equipment UE, but also a processing procedure in which a base station receives (monitors) D2D signals, and a processing procedure in which user equipment UE transmits uplink signals to a base station eNB during RRC idle or when no connection is established with the base station eNB.

<Overview of D2D>

First, an overview of D2D defined in LTE is described. V2X can also use the technique of D2D described herein, and a UE of the embodiment of the present invention can transmit and receive a D2D signal according to the technique.

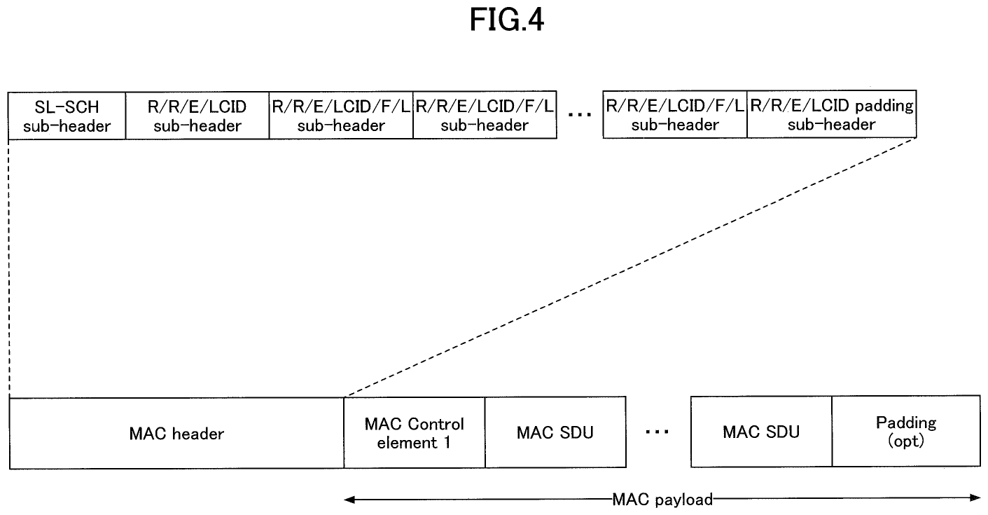

As described above, D2D is broadly classified into “D2D discovery” and “D2D communication”. As illustrated in FIG. 3A, in “D2D discovery,” a resource pool for discovery messages is secured for each discovery period and a UE transmits a discovery message in the resource pool. More specifically, there are Type 1 and Type 2b. In Type 1, a UE autonomously selects a transmission resource from a resource pool. In Type 2b, a semi-static resource is allocated by higher-layer signaling (for example, a RRC signal).

In “D2D communication,” SCI/data transmission resource pools are periodically reserved as illustrated in FIG. 3B. A transmission-side UE notifies a data transmission resource (a PSSCH resource pool) or the like to the reception side using a resource selected from a control resource pool (a PSCCH resource pool) via SCI and transmits data using the data transmission resource. More specifically, for the “D2D communication,” there are Mode 1 and Mode 2. In Mode 1, resources are dynamically allocated by (E)PDCCH transmitted from an eNB to a UE. In Mode 2, a UE autonomously selects a transmission resource from a resource pool. A resource pool notified using SIB or a predetermined resource pool is used as the resource pool.

In LTE, a channel used in “D2D discovery” is referred to as Physical Sidelink Discovery Channel (PSDCH), a channel used for transmitting control information such as SCI in “D2D communication” is referred to as Physical Sidelink Control Channel (PSCCH), and a channel used for transmitting data is referred to as Physical Sidelink Shared Channel (PSSCH) (see Non-Patent Document 2).

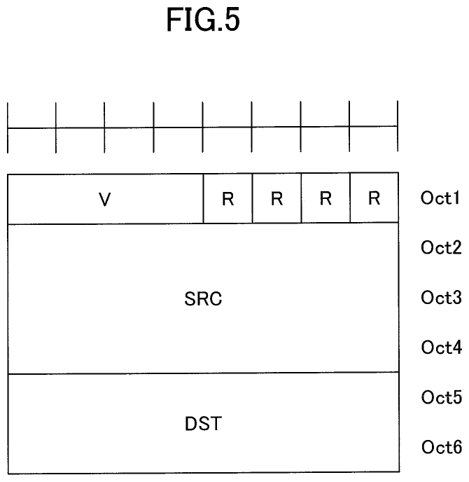

A Medium Access Control (MAC) Protocol Data Unit (PDU) used in D2D communication includes at least a MAC header, a MAC control element, a MAC Service Data Unit (SCU), and padding as illustrated in FIG. 4. The MAC PDU may include other information. The MAC header includes one Sidelink Shared Channel (SL-SCH) subheader and one or more MAC PDU subheaders.

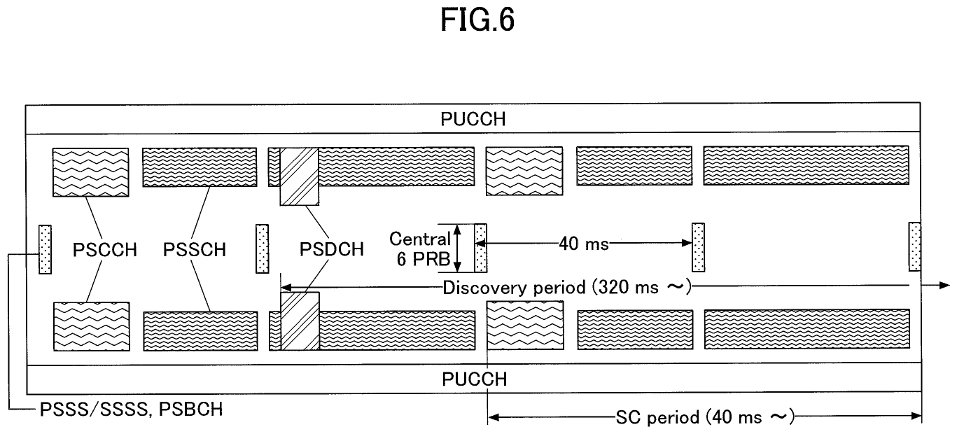

As illustrated in FIG. 5, the SL-SCH subheader includes a MAC PDU format version (V), transmission source information (SRC), transmission destination information (DST), a reserved bit (R), etc. V is allocated to the start of the SL-SCH subheader and indicates a MAC PDU format version used by a UE. Information on a transmission source is set to the transmission source information. An identifier of a ProSe UE ID may be set to the transmission source information. Information on a transmission destination is set to the transmission destination information. Information on a ProSe Layer-2 Group ID of a transmission destination may be set to the transmission destination information.

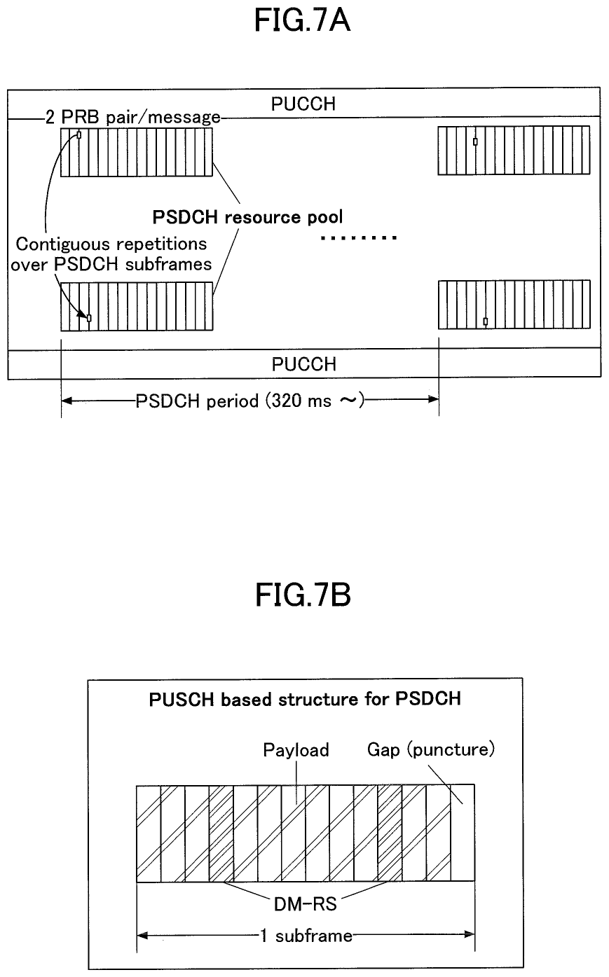

FIG. 6 illustrates an example of a channel structure of D2D. As illustrated in FIG. 6, a PSCCH resource pool and a PSSCH resource pool to be used for “D2D communication” are allocated. Moreover, a PSDCH resource pool to be used for “D2D discovery” is allocated at a period longer than the period of the channel of “D2D communication”.

A Primary Sidelink Synchronization signal (PSSS) and a Secondary Sidelink Synchronization signal (SSSS) are used as a D2D synchronization signal. Moreover, Physical Sidelink Broadcast Channel (PSBCH) in which broadcast information (broadcast information) such as a system band of D2D, a frame number, or system configuration information, is transmitted is used for out-of-coverage operations, for example.

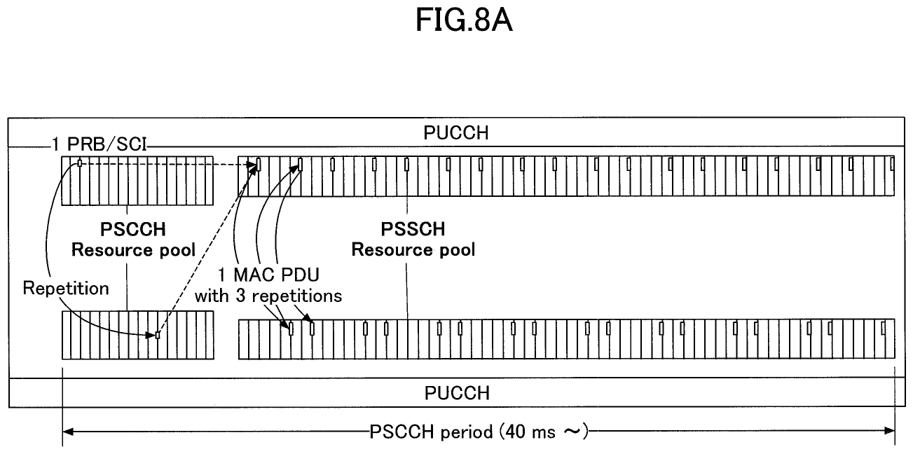

FIG. 7A illustrates an example of a PSDCH resource pool used for “D2D discovery”. Since a resource pool is configured by a bitmap of a subframe, the resource pool is represented by such an image as illustrated in FIG. 7A. The same is true for the resource pool of any other channel. Moreover, PSDCH is repeatedly transmitted (repetition) using frequency hopping. The number of repetitions can be set to 0 to 4, for example. Moreover, as illustrated in FIG. 7B, PSDCH has a PUSCH-based structure and has a structure in which a demodulation reference signal (DM-RS) is inserted.

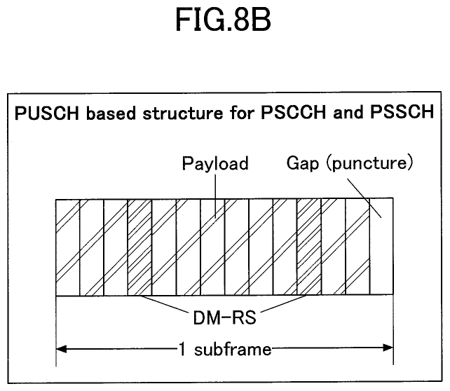

FIG. 8A illustrates an example of PSCCH and PSSCH resource pools to be used for “D2D communication”. As illustrated in FIG. 8A, PSCCH is repeatedly transmitted (repetition) twice including the first time using frequency hopping. PSSCH is repeatedly transmitted (repetition) four times including the first time using frequency hopping. As illustrated in FIG. 8B, PSCCH and PSSCH have a PUSCH-based structure and has a structure in which DMRS is inserted.

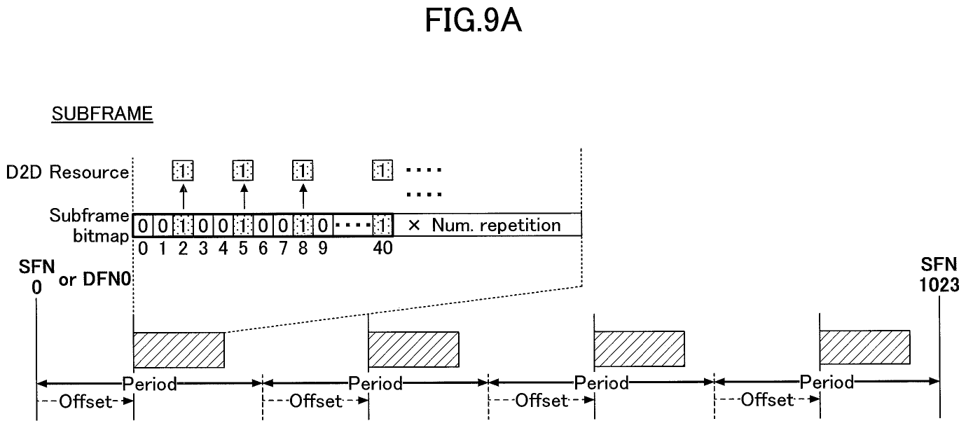

FIG. 9 illustrate an example of a resource pool configuration of PSCCH, PSDCH, and PSSCH (Mode 2). As illustrated in FIG. 9A, a resource pool is represented as a subframe bitmap in the time direction. Moreover, the bitmap is repeated by the number of num.repetition. Moreover, an offset indicating the starting position of each period is designated.

In the frequency direction, continuous allocation (contiguous) and discontinuous allocation (non-contiguous) are possible. FIG. 9B illustrates an example of discontinuous allocation, and as depicted, starting PRB, ending PRB, and the number of PRBs (numPRB) are designated.

<System Configuration>

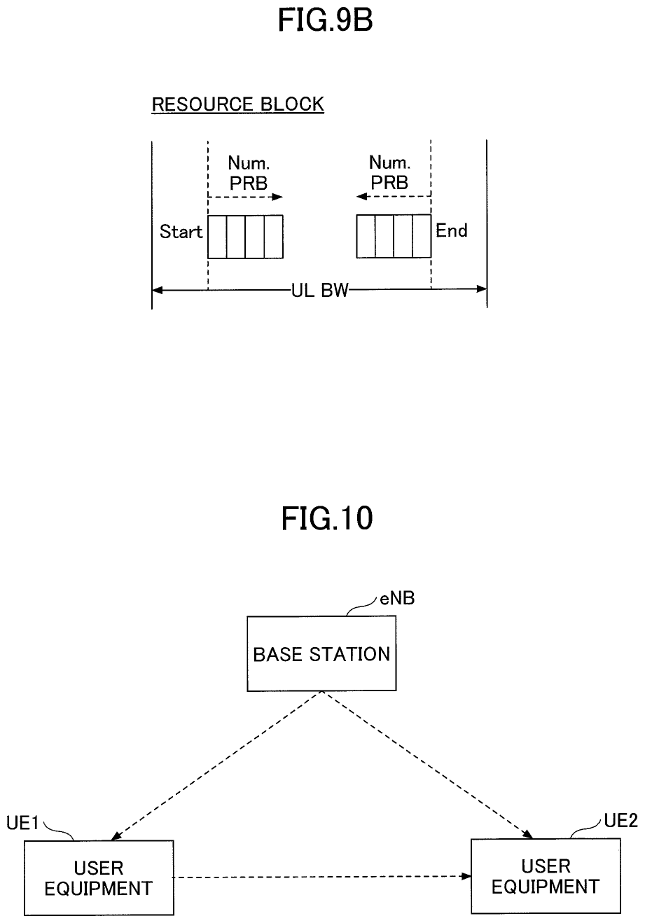

FIG. 10 is a diagram illustrating a configuration example of a wireless communication system according to an embodiment. As illustrated in FIG. 10, the wireless communication system according to the present embodiment includes a base station eNB, user equipment UE1, and user equipment UE2. In FIG. 10, although it is intended that the user equipment UE1 is a transmission side and the user equipment UE2 is a reception side, the user equipment UE1 and the user equipment UE2 both may have both a transmission function and a reception function. Hereinafter, the user equipment UE1 and the user equipment UE2 are described simply as “user equipment UE” when the units of user equipment are not particularly distinguished from each other.

The user equipment UE1 and the user equipment UE2 illustrated in FIG. 10 each have a cellular communication function as the user equipment UE in LTE and a D2D function including transmission and reception of signals in the above-described channel. Moreover, each of the user equipment UE1 and the user equipment UE2 has a function of executing operations to be described in the present embodiment. The units of user equipment UEs may have all or some of the cellular communication function and the existing D2D function (within a range in which the operations to be described in the present embodiment can be executed).

Each user equipment UE may be any device having the D2D function; however, for example, each user equipment UE is a vehicle, a terminal carried by a pedestrian, a RSU (UE-type RSUs having the function of the UE), etc.

The base station eNB has a cellular communication function of a base station eNB in LTE and functions (a resource allocation function, a configuration information notification function, etc.) for enabling communication of units of user equipment UEs in the present embodiment. Moreover, the base station eNB includes a RSU (an eNB-type RSU having the function of an eNB).

<Processing Procedure>

Hereinafter, a specific processing procedure performed by the user equipment UE according to the embodiment is described. In the following description, although a resource pool for transmitting control information is referred to as a “SCI resource pool” for the sake of convenience, the resource pool is not intended to be limited to this. In the present embodiment, the resource pool also includes resource pools called by the name of “PSCCH resource pool” and “Scheduling Assignment (SA)” resource pool) used in the conventional D2D and a resource pool called by the name which may be newly defined in 5G, ect. Moreover, although a resource pool for transmitting data is referred to as a “data resource pool” for the sake of convenience, the resource pool is not intended to be limited to this. The present embodiment includes “PSSCH resource pool” used in usual D2D and a resource called by a name which may be newly defined in 5G, etc.

In the following description, although control information used in D2D communication is referred to as “SCI,” the control information is not intended to be limited to this. In the present embodiment, the control information also includes control information called by the name of “SA” used in the usual D2D and control information called by the name which may be newly defined in 5G, etc.

In the present embodiment, it is assumed that the SCI resource pool and the data resource pool are frequency-multiplexed. Moreover, although it is assumed that the SCI resource pool is configured in the upper and lower regions of a region in which the data resource pool is configured, the SCI resource pool is not limited to this but may not be configured in the upper and lower regions of the region in which the data resource pool is configured. For example, the SCI resource pool is configured in the upper (or lower) region and the data resource pool may be configured in the lower (or upper) region.

In the present embodiment, it is assumed that in order to allow the reception-side user equipment UE to combine a plurality of items of received SCI, the location of a resource that the transmission-side user equipment UE selects to transmit the second and subsequent times of SCI is uniquely determined from the resource location at which the first time of SCI is transmitted according to a predetermined resource selection method (hopping pattern). That is, it is assumed that the transmission-side user equipment UE and the reception-side user equipment UE recognize the predetermined resource selection method. Moreover, it is assumed that information indicating the resource location at which data is repeatedly transmitted a plurality of number of times is included in the SCI. That is, the reception-side user equipment UE recognizes the resource location at which data is repeatedly transmitted a plurality of number of times based on the information included in the received SCI.

(SCI and Data Repeat Transmission Method)

When transmitting data to a reception-side user equipment UE, the user equipment UE according to the present embodiment selects a plurality of SCI transmission resources for repeatedly transmitting SCI from a SCI resource pool, selects a plurality of data transmission resources for repeatedly transmitting data from a data resource pool, and repeatedly transmits SCI of the same content and data of the same data using the plurality of selected SCI transmission resources and the plurality of selected data transmission resources.

Here, the user equipment UE selects the plurality of SCI transmission resources and the plurality of data transmission resources so that a SCI transmission resource for transmitting SCI for the first time (for the first time) and a data transmission resource for transmitting data for the first time (for the first time) are located in the same subframe.

The plurality of SCI transmission resources defined by the predetermined resource selection method may be defined, so that the plurality of SCI transmission resources are frequency-hopped between the upper-side SCI resource pool and the lower-side SCI resource pool in the frequency direction. Moreover, the user equipment UE may select the plurality of data transmission resources, so that the plurality of data transmission resources are frequency-hopped between a resource pool in the upper-half part in the frequency direction of a data resource pool and a resource pool in the lower-half part. In this manner, a frequency diversity effect can be obtained in the reception-side user equipment UE.

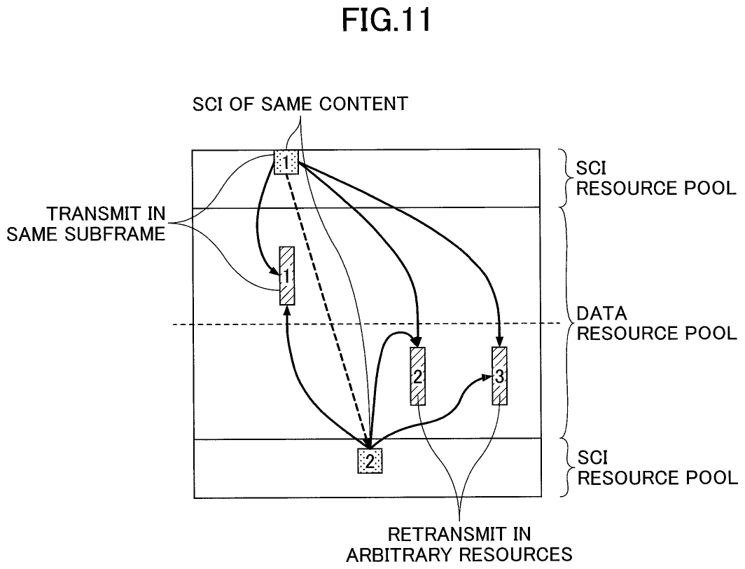

FIG. 11 is a diagram illustrating a SCI and data repeat transmission method. As illustrated in FIG. 11, the user equipment UE according to the present embodiment selects resources so that the resource of SCI transmitted for the first time and the resource of data transmitted for the first time are located in the same subframe. Moreover, the user equipment UE selects resources to be used for repeatedly transmitting data in the second and subsequent times from arbitrary resources which are subframes located subsequent to a subframe (the subframe in which SCI and data are transmitted simultaneously) in which SCI is transmitted for the first time. In the example of FIG. 11, an example is illustrated in which SCI is repeatedly transmitted twice and data is repeatedly transmitted three times. However, the present invention is not limited to this, and SCI may be repeatedly transmitted three or more times and data may be repeatedly transmitted twice or four or more times.

By repeatedly transmitting SCI and data according to the above-described method, the reception-side user equipment UE can perform combining reception of SCI and data. Moreover, since SCI and data are repeatedly transmitted, it is possible to perform control so that the occurrence of a problem (a half-duplex problem) that a plurality of units of user equipment UEs transmits D2D signals in the same subframe and one user equipment UE cannot receive the D2D signal transmitted by the other user equipment UE is prevented as much as possible. Moreover, since the transmission-side user equipment UE transmits SCI transmitted for the first time and data transmitted for the first time using the same subframe, it is possible to reduce the transmission latency as compared to the conventional D2D communication. Moreover, since the transmission-side user equipment UE can select the resource for transmitting data from any resource, more flexible D2D communication can be performed.

(Selection Method for Selecting Resource Location for Transmitting SCI and Data in First Time)

The transmission-side user equipment UE may select resources using the following selection method in order to suppress different units of user equipment UEs from selecting the same resource when selecting resources for transmitting SCI and data for the first time.

[Selection Method (Version 1)]

In the selection method (version 1), it is assumed that the user equipment UE can reserve a resource for transmitting new SCI (or new SCI and data) after the elapse of a predetermined period (a predetermined subframe) by inserting resource reservation information in SCI. Moreover, a resource reservation window is intended to mean a period in which SCI including the resource reservation information is to be transmitted, and a resource selection window is intended to mean a period in which a resource can be reserved by the resource reservation information. That is, the user equipment UE can detect a reservation state of a resource in a resource selection window by monitoring the resource reservation window and can transmit SCI/data using a resource which is not reserved among resources in the resource selection window.

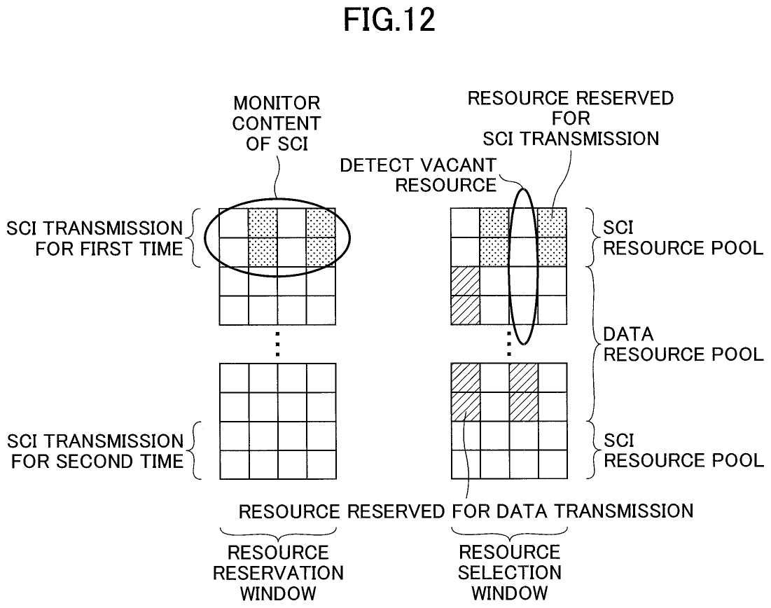

As illustrated in FIG. 12, the user equipment UE receives SCI transmitted from other units of user equipment UEs and acquires the resource reservation information included in the received SCI by monitoring resources in a SCI resource pool that transmits SCI for the first time in the period of the resource reservation window. Subsequently, the user equipment UE determines a reservation state of resources based on the acquired resource reservation information. When it is determined that a resource capable of transmitting SCI and data in the same subframe is vacant (the resource is not reserved) among the resources in the resource selection window, the user equipment UE selects the resource as a resource for transmitting SCI and data for the first time.

When it is determined that a resource capable of transmitting SCI only is vacant (the resource capable of receiving data is not vacant) among the resources in the resource selection window, the vacant resource may be selected as a resource for transmitting SCI, and an arbitrary resource in the data resource pool in the same subframe as the selected resource may be selected as a resource for transmitting data. The reason is that, in the present embodiment, occurrence of slight interference is tolerated because it is assumed that SCI and data are repeatedly transmitted, and it is not always true that data is transmitted from any other user equipment UE using a reserved resource.

Similarly, when it is determined that a resource capable of transmitting data only is vacant (the resource capable of receiving SCI is not vacant) among the resources in the resource selection window, the vacant resource may be selected as a resource for transmitting data, and an arbitrary resource in the SCI resource pool in the same subframe as the selected resource may be selected as a resource for transmitting SCI. In the present embodiment, since it is assumed that SCI and data are repeatedly transmitted and it is not always true that SCI is transmitted from any other user equipment UE using the reserved resource, the occurrence of slight interference is tolerated.

[Selection Method (Version 2)]

In the selection method (version 2), it is assumed that the user equipment UE can reserve a resource for transmitting new SCI (or new SCI and data) after the elapse of a predetermined period (a predetermined subframe) after transmitting SCI. Moreover, it is assumed that a resource to be used for transmitting SCI and data in the resource reservation window and a reservable resource (a resource in the resource selection window) are correlated with each other and the user equipment UE has information indicating the correlation in advance.

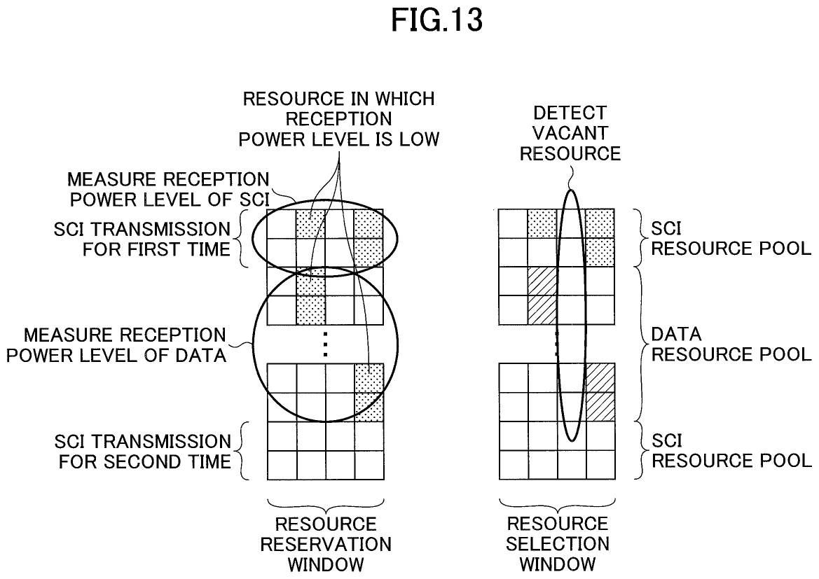

As illustrated in FIG. 13, the user equipment UE measures a reception power level of each resource in the SCI resource pool that transmits SCI for the first time and measures a reception power level of each resource in the data resource pool that transmits data. Subsequently, the user equipment UE determines a resource reservation state based on the measured reception power level. More specifically, the user equipment UE determines that SCI/data transmission resources in the resource selection window correlated with the resource location of SCI/data of which the reception power level is higher than or equal to a predetermined threshold are reserved and that SCI/data transmission resources in the resource selection window correlated with the resource location of SCI/data of which the reception power level is lower than the predetermined threshold are not reserved.

Subsequently, when it is determined that a resource capable of transmitting SCI and data in the same subframe among the resources in the resource selection window is vacant (the resource is not reserved), the user equipment UE selects the resource as a resource for transmitting SCI and data for the first time.

Similar to the first selection method, when it is determined that a resource capable of transmitting SCI only is vacant (the resource capable of receiving data is not vacant) among the resources in the resource selection window, the vacant resource may be selected as a resource for transmitting SCI, and an arbitrary resource in the data resource pool in the same subframe as the selected resource may be selected as a resource for transmitting data. Similarly, when it is determined that a resource capable of transmitting data only is vacant (the resource capable of receiving SCI is not vacant) among the resources in the resource selection window, the vacant resource may be selected as a resource for transmitting data, and an arbitrary resource in the SCI resource pool in the same subframe as the selected resource may be selected as a resource for transmitting SCI.

Note that the selection method (version 2) and the selection method (version 1) may be combined. For example, a resource for transmitting SCI may be selected in the resource selection window in accordance with the selection method (version 1), and a resource for transmitting data may be selected in the resource selection window in accordance with the selection method (version 2).

[Selection Method (Version 3)]

In the selection method (version 3), it is assumed that the user equipment UE can reserve a resource for transmitting new SCI (or new SCI and data) after the elapse of a predetermined period (a predetermined subframe) after transmitting SCI. Moreover, it is assumed that a resource to be used for transmitting SCI and data in the resource reservation window and a reservable resource (a resource in the resource selection window) are correlated with each other in respective subframes and the user equipment UE has information indicating the correlation in advance.

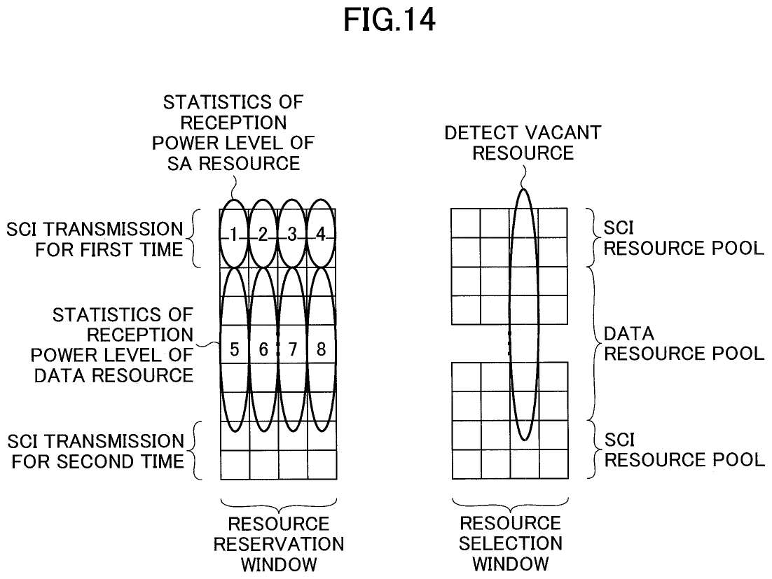

As illustrated in FIG. 14, the user equipment UE measures a reception power level of each resource in the SCI resource pool that transmits SCI for the first time and a reception power level of each resource in the data resource pool that transmits data in each subframe included in the period of the resource reservation window.

Subsequently, the user equipment UE selects one subframe using a statistical value (the largest value, the average value, or the smallest value) in respective subframes of the measured reception power levels of the resources in the SCI resource pool and a statistical value (the largest value, the average value, or the smallest value) in respective subframes of the measured reception power levels of the resources in the data resource pool.

Although an arbitrary method may be used as a method for selecting one subframe, for example, the user equipment UE may select a subframe in which the larger value among the statistical value of the reception power levels in the SCI resource pool and the statistical value of the reception power levels in the data resource pool is the smallest. The selection method is described in detail with reference to FIG. 14. The user equipment UE may compare the “larger value” among the statistical value of the reception power levels of resources in range “1” and the statistical value of the reception power levels of resources in range “5,” the “larger value” among the statistical value of the reception power levels of resources in range “2” and the statistical value of the reception power levels of resources in range “6,” the “larger value” among the statistical value of the reception power levels of resources in range “3” and the statistical value of the reception power levels of resources in range “7,” and the “larger value” among the statistical value of the reception power levels of resources in range “4” and the statistical value of the reception power levels of resources in range “8,” and select a subframe in which the “larger value” is the smallest.

As another method, for example, the user equipment UE may select a subframe in which the sum obtained by adding the statistical value of the reception power levels in the SCI resource pool and the statistical value of the reception power levels in the data resource pool by a predetermined percentage is the smallest. The selection method is described in detail with reference to FIG. 14. The user equipment UE may compare the sum obtained by adding the statistical value of the reception power levels of resources in range “1” and the statistical value of the reception power levels of resources in range “5” by a predetermined percentage, the sum obtained by adding the statistical value of the reception power levels of resources in range “2” and the statistical value of the reception power levels of resources in range “6” by a predetermined percentage, the sum obtained by adding the statistical value of the reception power levels of resources in range “3” and the statistical value of the reception power levels of resources in range “7” by a predetermined percentage, and the sum obtained by adding the statistical value of the reception power levels of resources in range “4” and the statistical value of the reception power levels of resources in range “8” by a predetermined percentage, and select a subframe in which the “sum” is the smallest.

Subsequently, the user equipment UE recognizes that a subframe in the resource selection window correlated with the selected subframe is a subframe in which a resource is not reserved and selects the resource in the subframe as a resource for transmitting SCI and data for the first time.

(Selection Method for Selecting Resource Location for Transmitting Data in Second Time)

As described above, the user equipment UE according to the present embodiment selects a resource to be used for repeatedly transmitting data in the second and subsequent times from arbitrary resources which are subframes located subsequent to a subframe (the subframe in which SCI and data are transmitted simultaneously) in which SCI is transmitted for the first time. More specifically, the user equipment UE may select the resource location for transmitting data in the second and subsequent times according to the following selection method.

[Selection Method (Version 1)]

In the selection method (version 1), the user equipment UE may select a resource for repeatedly transmitting data for the second time among a plurality of data transmission resources from arbitrary subframes located between a subframe which is located subsequent to the subframe for transmitting SCI for the first time and a subframe located previous to the subframe for transmitting SCI for the second time. When data is repeatedly transmitted three or more times, the user equipment UE may select a resource for repeatedly transmitting data in the third and subsequent times from arbitrary resources which are subframes (including the subframe located subsequent to the subframe for transmitting SCI for the second time) located subsequent to the subframe for transmitting data for the second time.

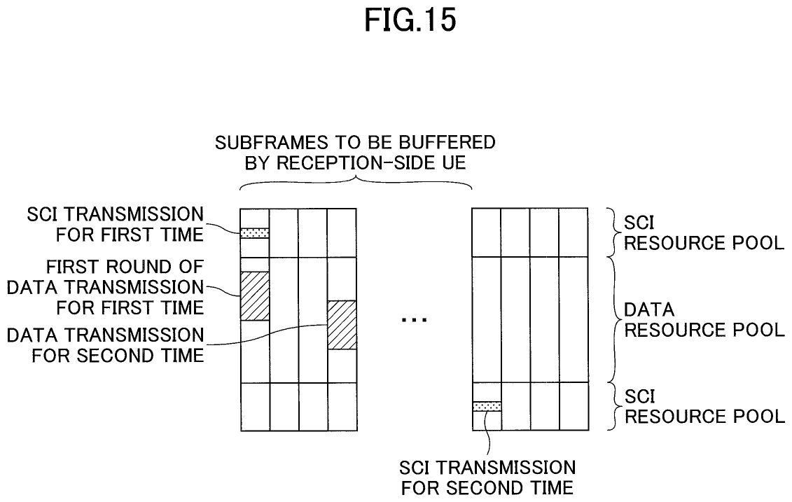

In the example of FIG. 15, when the reception-side user equipment UE failed to receive SCI for the first time (for example, failed to decode the SCI), the reception-side user equipment UE may buffer signals of all subframes extending from the subframe used for receiving SCI for the first time to a subframe located immediately before the subframe used for transmitting SCI for the second time in a memory, etc. When the reception-side user equipment UE succeeds in decoding SCI for the second time (or succeeds in decoding by performing combining reception of the first and second times of SCI), the reception-side user equipment UE may decode data from signals of the subframe in the buffer based on information indicating the resource location of data included in the SCI. Since at least two times of data signals are included in the buffer, the reception-side user equipment UE can combine and decode two times of data signals as necessary.

[Second Selection Method]

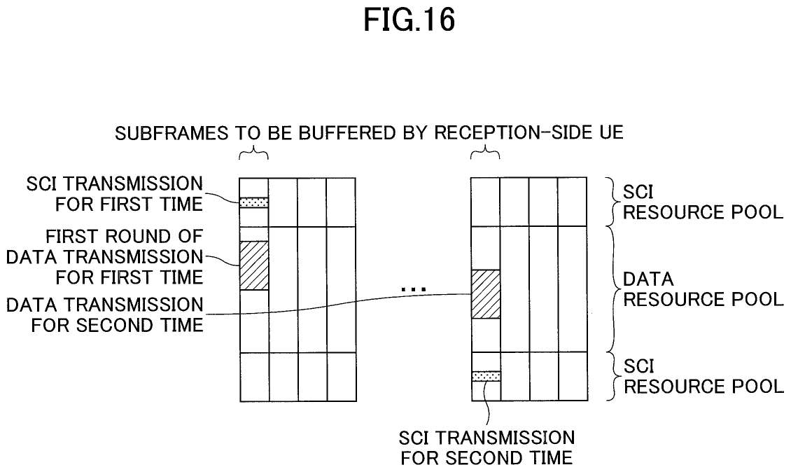

In a second selection method, as illustrated in FIG. 16, the user equipment UE may select a resource for repeatedly transmitting data for the second time among the plurality of data transmission resources from subframes located subsequent to the subframe to be used for transmitting SCI for the second time. When data is repeatedly transmitted three or more times, the user equipment UE may select a resource for repeatedly transmitting data for the third and subsequent times from arbitrary resources which are subframes located subsequent to the subframe for transmitting data for the second time.

In the example of FIG. 16, when the reception-side user equipment UE fails to receive SCI for the first time (for example, failed to decode the SCI), the reception-side user equipment UE may buffer signals of the subframe used for receiving SCI for the first time and signals of the subframe used for transmitting SCI for the second time in a memory or the like. When the reception-side user equipment UE succeeds in decoding SCI for the second time (or succeeds in decoding by performing combining reception of the first and second times of SCI), the reception-side user equipment UE may decode data from signals of the subframe in the buffer based on information indicating the resource location of data included in the SCI. Since at least one time of data signals are included in the buffer, the reception-side user equipment UE can combine and decode subsequent times of data signals as necessary.

(Selection Method for Selecting Resource for Transmitting SCI)

In the present embodiment, it is assumed that in order to allow the reception-side user equipment UE to combine a plurality of items of received SCI, the location of a resource that the transmission-side user equipment UE selects to transmit the second and subsequent times of SCI is uniquely determined from the resource location at which the first time of SCI is transmitted according to a predetermined resource selection method (hopping pattern). Here, in the present embodiment, a resource selection method which extends the resource selection method (hopping pattern) defined by 3GPP Rel-12 may be used as the predetermined resource selection method. In the present embodiment, although an example in which SCI is transmitted using one continuous frequency resource per one subframe is described, the present invention is not limited to this, but SCI may be transmitted using a discontinuous frequency resource. For example, the user equipment UE may switch ON/OFF whether discontinuous frequency resources are to be used for transmission based on upper-layer signaling (for example, broadcast information, RRC signaling, or the like) or pre-configuration. When discontinuous frequency resources are used for transmission, the user equipment UE may transmit SCI using two discontinuous frequency resources including one continuous frequency resource (for example, 1PRB resource) and another continuous frequency resource which is in a mirror image relation within a system bandwidth or a SCI resource pool or another continuous frequency resource which is in an offset relation with a fixed frequency resource. Here, the user equipment UE may perform coding across continuous frequency resources and may perform coding on each fixed frequency resource size (each continuous frequency resource or the like) to transmit SCI, and the reception-side user equipment UE may perform combining reception of items of SCI. In this case, the user equipment UE may transmit signals of respective continuous frequency resources by different Redundancy Versions (RV) determined based on certain rules.

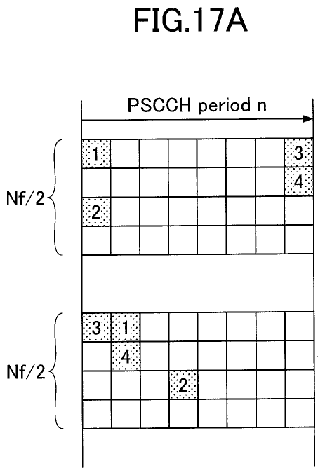

FIG. 17 is a diagram illustrating a selection method for selecting a resource location at which SCI is repeatedly transmitted. In FIG. 17, “Nf” means the number of resources (the number of RBs (Resource Blocks) in the frequency direction) in the frequency direction of the SCI resource pool.

FIG. 17A illustrates the image of a resource selection method defined by Rel-12. In FIG. 17A, two resources denoted by the same number indicate the resource locations at which the same SCI is repeatedly transmitted. In the resource selection method defined by Rel-12, it is defined that the SCI transmitted for the first time in the PSCCH period and the SCI transmitted for the second time are transmitted so as to frequency-hop between the upper-side (or the lower-side) SCI resource pool in the frequency direction and the lower-side (or the upper-side) SCI resource pool. Moreover, it is defined that two items of SCI transmitted in the same subframe and using different frequency resources for the first time of transmission are transmitted in a subframe different from that for the second time of transmission. A more specific resource selection method is defined in Sections 14.2.1.1 and 14.2.1.2 of 3GPP TS36.213.

Here, in the resource selection method of Rel-12, it is assumed that the SCI transmitted for the first time and the SCI transmitted for the second time are transmitted in the same PSCCH period. Therefore, depending on the resource location of the SCI transmitted for the first time, the subframe interval between the SCI transmitted for the first time and the SCI transmitted for the second time may be vacant. For example, in the example of FIG. 17A, although the subframe interval between the SCI transmitted for the first time and the SCI transmitted for the second time is 1 subframe for the subframe of the resource indicated by “1,” the subframe interval between the SCI transmitted for the first time and the SCI transmitted for the second time is 7 subframes for the subframe of the resource indicated by “3”.

Accordingly, in the present embodiment, the SCI resource pool is split into a plurality of continuous PSCCH periods. Moreover, when the subframe interval between the SCI transmitted for the first time and the SCI transmitted for the second time defined according to the resource selection method of Rel-12 is longer than the number of subframes in the half period of the PSCCH period (four subframes in FIG. 17A), the user equipment UE regards that the resource location of the SCI transmitted for the second time defined according to the resource selection method of Rel-12 is the resource location of the SCI transmitted for the first time and that the resource location of the SCI transmitted for the first time in the subsequent PSCCH period is the resource location of the SCI transmitted for the second time. A specific example is illustrated in FIG. 17B. For example, in FIG. 17A, the subframe interval between the SCI transmitted for the first time and the SCI transmitted for the second times for the items of SCI indicated by “3” and “4” is more vacant than the half (4 subframes) of the PSCCH period (8 subframes). Therefore, as illustrated in FIG. 17B, the user equipment UE regards that, for the items of SCI indicated by “3” and “4,” the resource location of the SCI transmitted for the second time in a predetermined PSCCH period (n) is the resource location of the SCI transmitted for the first time and that the resource location of the SCI transmitted for the first time in the PSCCH period (n+1) subsequent to the predetermined PSCCH period (n) is the resource location of the SCI transmitted for the second time.

The resource selection method which extends the resource selection method defined by 3GPP Rel-12 is described above. According to the resource selection method, since the time interval at which SCI is repeatedly transmitted is shortened, it is possible to reduce the latency when the reception-side user equipment UE performs combining reception of a plurality of items of SCI.

(Data Repeat Transmission Across PSCCH Period)

In the specifications of Rel-12, both the SCI resource pool and the data resource pool are included in one PSCCH period, but repeated transmission of the same SCI and the same data across the PSCCH period is not taken into consideration. However, when the resource selection method which extends the resource selection method defined by the 3GPP Rel-12 is used, SCI is repeatedly transmitted across the PSCCH period. Therefore, in the present embodiment, the data resource pool may be also split into a plurality of continuous PSCCH periods, and the user equipment UE may repeatedly transmit data across the PSCCH period.

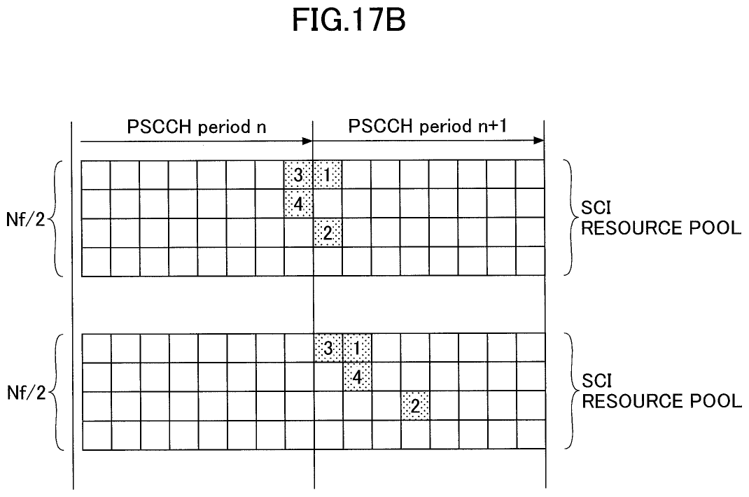

FIG. 18 is a diagram illustrating a case in which data is repeatedly transmitted across the PSCCH period. As illustrated in FIG. 18, when SIC is repeatedly transmitted across the PSCCH period, the user equipment UE may select a resource for repeatedly transmitting data across the PSCCH period. Moreover, the user equipment UE may select a resource for repeatedly transmitting data among resources in a “data retransmission period” which has the same length as the PSCCH period. In this manner, the user equipment UE can finish retransmission of data until the timing (specifically, the timing of the resource location indicated by “1” of the PSCCH period (n+1)) at which new SCI can be transmitted for the first time.

In 3GPP Rel-12, it is defined that a subframe location of a resource for transmitting data is designated by a bitmap called T-RPT included in the SCI. Moreover, the specifications of Rel-12 defines that T-RPT starts from the first subframe of a data resource pool in the same PSCCH period as a PSCCH period in which SCI is transmitted.

Therefore, in the present embodiment, when SCI is repeatedly transmitted across the PSCCH period, the T-RPT included in the SCI may be explicitly or implicitly configured so that the T-RPT starts from a subframe in which SCI is transmitted for the first time. In the present embodiment, since the SCI and data transmitted for the first time are transmitted in the same subframe, it is less necessary to designate the subframe for transmitting data for the first time as T-RPT. Thus, when SCI is repeatedly transmitted across the PSCCH period, the T-RPT included in the SCI may be explicitly or implicitly configured so that the T-RPT starts from the first subframe of the PSCCH period subsequent to the PSCCH period in which SCI is transmitted for the first time. The case in which data is repeatedly transmitted across the PSCCH period is described above.

<Functional Configuration>

Functional configuration examples of the user equipment UE and the base station eNB that execute the operation of the plurality of embodiments described above are described.

(User Equipment)

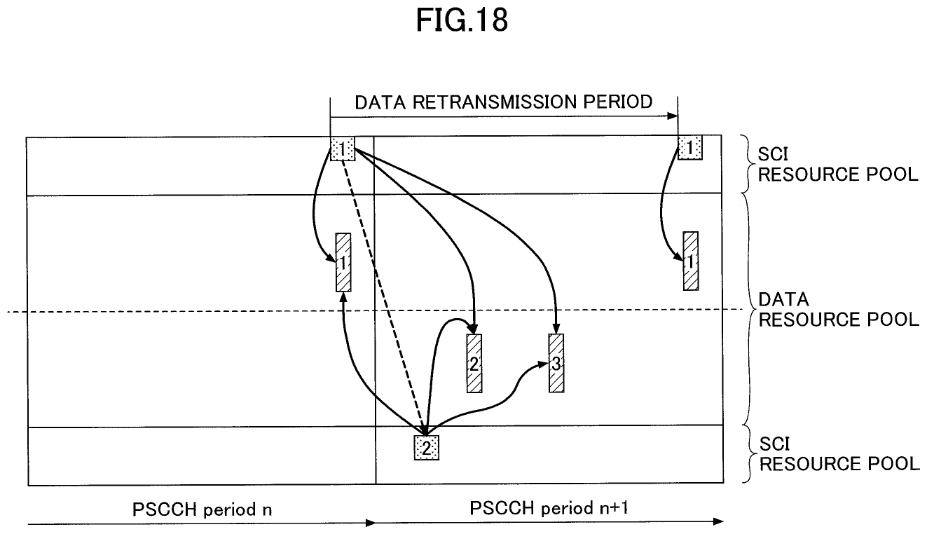

FIG. 19 is a diagram illustrating an example of a functional configuration of user equipment according to the embodiment. As illustrated in FIG. 19, the user equipment UE includes a signal transmission unit 101, a signal reception unit 102, and a selection unit 103. FIG. 19 illustrates functional units of the user equipment UE particularly related to the embodiment only and also includes at least functions (not illustrated) for performing operations conforming to LTE. Moreover, the functional configuration illustrated in FIG. 19 is merely an example. The functional classifications and the names of the functional units are not particularly limited as long as the operations according to the present embodiment can be executed. However, a part of the process of the user equipment UE described above (example: specific one or more modifications, only specific example, etc.) may be made executable.

The signal transmission unit 101 includes a function of generating various signals of the physical layer from higher-layer signals to be transmitted from the user equipment UE and transmitting the signals wirelessly. Moreover, the signal transmission unit 101 has a D2D signal transmission function and a cellular communication transmission function. Furthermore, the signal transmission unit 101 has a function of transmitting the D2D signal using a resource selected by the selection unit 103. Furthermore, the signal transmission unit 101 has a function of repeatedly transmitting SCI including information that designates a plurality of data transmission resources using a plurality of SCI transmission resources and repeatedly transmitting data using a plurality of data transmission resources.

The signal reception unit 102 includes a function of wirelessly receiving various signals from the other user equipment UE or the base station eNB and acquiring higher-layer signals from the received physical layer signals. Moreover, the signal reception unit 102 has a D2D signal receiving function and a cellular communication receiving function.

The selection unit 103 has a function of selecting a plurality of SCI transmission resources and a plurality of data transmission resources so that a SCI transmission resource for transmitting SCI for the first time among the plurality of SCI transmission resources and a data transmission resource for transmitting data for the first time among the plurality of data transmission resources are in the same subframe.

Moreover, the selection unit 103 may select a data transmission resource for transmitting data for the second time among the plurality of data transmission resources from subframes located between a subframe subsequent to the subframe of the SCI transmission resource for transmitting SCI for the first time among the plurality of SCI transmission resources and a subframe prior to the subframe of the SCI transmission resource for transmitting SCI for the second time.

The selection unit 103 may select a data transmission resource for transmitting data for the second time among the plurality of data transmission resources from subframes located subsequent to the subframe of the SCI transmission resource for transmitting SCI for the second time among the plurality of SCI transmission resources.

The selection unit 103 may select a plurality of SCI transmission resources so that the SCI transmission resource for transmitting SCI for the first time among the plurality of SCI transmission resources and the SCI transmission resource for transmitting SCI for the second time are in different PSCCH periods. In this case, the SCI resource pool may be split into a plurality of continuous PSCCH periods.

The selection unit 103 may select the plurality of data resources so that the data transmission resource for transmitting data for the first time among the plurality of data transmission resources and the data transmission resource for transmitting data for the second time are located in different PSCCH periods. In this case, the data resource pool may be split into a plurality of continuous PSCCH periods.

The selection unit 103 may determine a reservation state of resources in a SCI resource pool and a reservation state of resources in a data resource pool by acquiring the SCI transmitted from other units of user equipment UEs in the SCI resource pool, select a plurality of SCI transmission resources for repeatedly transmitting SCI among resources which are determined to be vacant within the SCI resource pool, and select a plurality of data transmission resources for repeatedly transmitting data among the resources which are determined to be vacant within the data resource pool.

The selection unit 103 may determine a reservation state of resources in the SCI resource pool based on the reception power levels in respective resources of the SCI resource pool and select a plurality of SCI transmission resources for repeatedly transmitting SCI from resources which are determined to be vacant within the SCI resource pool. Moreover, the selection unit 103 may determine a reservation state of resources in the data resource pool based on the reception power levels in respective resources of the data resource pool and select a plurality of data transmission resources for repeatedly transmitting data among the resources which are determined to be vacant within the data resource pool.

(Base Station)

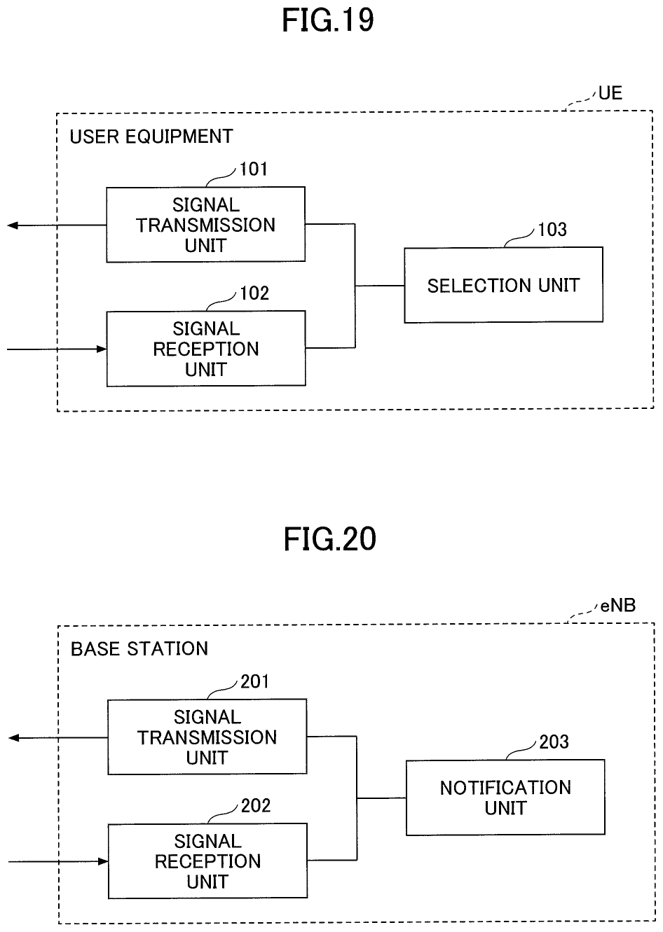

FIG. 20 is a diagram illustrating an example of a functional configuration of a base station according to the embodiment. As illustrated in FIG. 20, the base station eNB includes a signal transmission unit 201, a signal reception unit 202, and a notification unit 203. FIG. 20 illustrates functional units of the base station eNB particularly related to the embodiment only and also includes at least functions (not illustrated) for performing operations compatible with LTE. Moreover, the functional configuration illustrated in FIG. 20 is merely an example. The functional classifications and the names of the functional units are not particularly limited as long as the operations according to the present embodiment can be executed. However, a part of the process of the base station eNB described above (example: specific one or more modifications, only specific example, etc.) may be made executable.

The signal transmission unit 201 includes a function of generating various signals of the physical layer from higher-layer signals to be transmitted from the base station eNB and transmitting the signals wirelessly. The signal reception unit 202 includes a function of wirelessly receiving various signals from the user equipment UE and acquiring higher-layer signals from the received physical layer signals.

The notification unit 203 notifies the user equipment UE of various items of information that the user equipment UE uses to perform the operation of the present embodiment using the broadcast information (SIB) or the RRC signaling. Examples of various items of information include information indicating the configuration of the SCI resource pool and the data resource pool, information indicating the splitting positions of the PSCCH period in the SCI resource pool, information indicating the splitting positions of the PSCCH period in the data resource pool, or information indicating the location of the subframe serving as the starting point of T-RPT.

The functional configuration of each of the base station eNB and the user equipment UE described above may be implemented entirely by a hardware circuit (e.g., one or more IC chips); or a part of the functional configuration of each of the base station eNB and the user equipment UE described above may be formed of a hardware circuit, and the other part may be implemented by a CPU and a program.

(User Equipment)

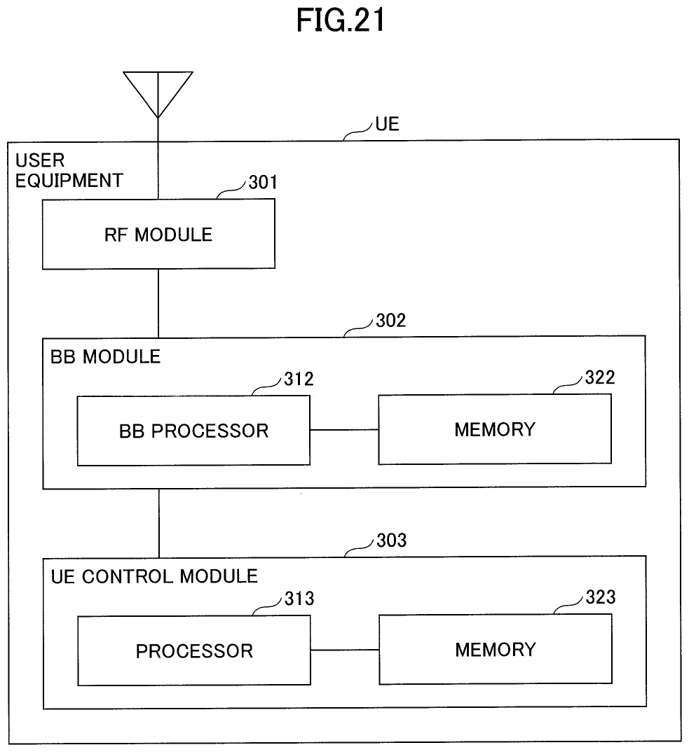

FIG. 21 is a diagram illustrating an example of a hardware configuration of the user equipment according to the embodiment. FIG. 21 illustrates a configuration closer to an implementation example compared to FIG. 19. As illustrated in FIG. 21, the user equipment UE includes a Radio Frequency (RF) module 301 that performs processing on radio signals, a Base Band (BB) processing module 302 that performs baseband signal processing, and a UE control module 303 that performs processing of higher layers and the like.

The RF module 301 generates radio signals to be transmitted from an antenna by performing Digital-to-Analog (D/A) conversion, modulation, frequency conversion, power amplification, etc., on the digital baseband signals received from the BB processing module 302. Moreover, the RF module 301 generates digital baseband signals by performing frequency conversion, Analog to Digital (A/D) conversion, demodulation, etc., on the received radio signals and delivers the generated digital baseband signals to the BB processing module 302. The RF module 301 includes a portion of the signal transmission unit 101 and the signal reception unit 102 illustrated in FIG. 19, for example.

The BB processing module 302 performs a process of converting an IP packet and a digital baseband signal or vice versa. A Digital Signal Processor (DSP) 312 is a processor that performs signal processing in the BB processing module 302. A memory 322 is used as a work area of the DSP 312. The RF module 301 includes a portion of the signal transmission unit 101, a portion of the signal reception unit 102, and the selection unit 103 illustrated in FIG. 19, for example.

The UE control module 303 performs protocol processing of the IP layer and processing of various applications. A processor 313 is a processor that performs the processing performed by the UE control module 303. A memory 323 is used as a work area of the processor 313.

(Base Station)

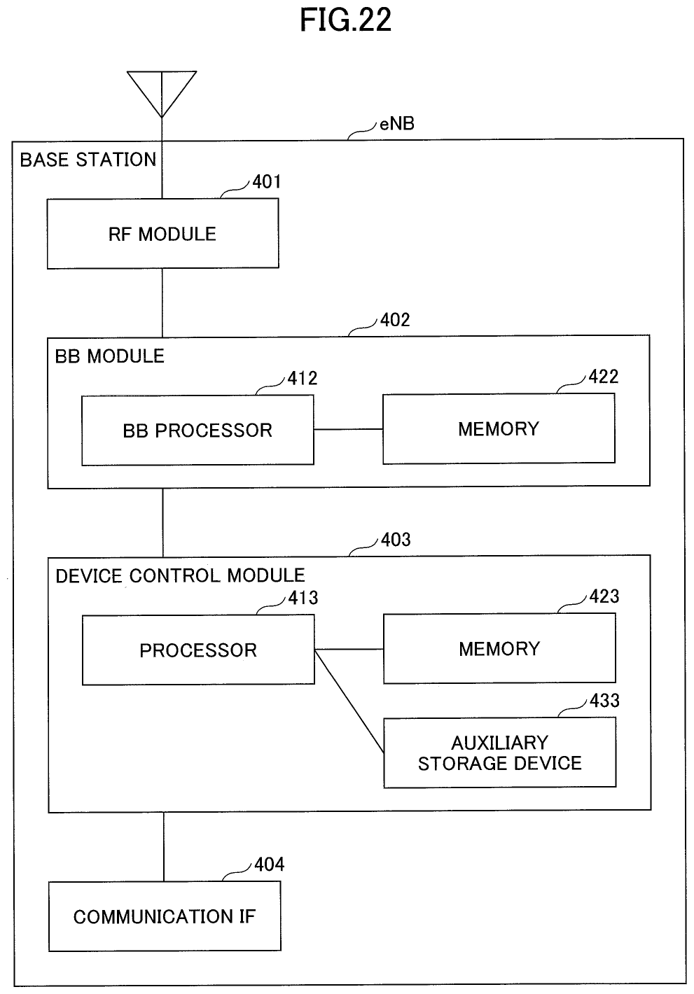

FIG. 22 is a diagram illustrating an example of a hardware configuration of a base station according to the embodiment. FIG. 22 illustrates a configuration closer to an implementation example compared to FIG. 20. As illustrated in FIG. 22, the base station eNB includes an RF module 401 that performs processing on radio signals, a BB processing module 402 that performs baseband signal processing, a device control module 403 that performs processing of higher layers and the like, and a communication IF 404 which is an interface for connecting to a network.

The RF module 401 generates radio signals to be transmitted from an antenna by performing D/A conversion, modulation, frequency conversion, power amplification, and the like on the digital baseband signals received from the BB processing module 402. Moreover, the RF module 401 generates digital baseband signals by performing frequency conversion, A/D conversion, demodulation, and the like on the received radio signals and delivers the generated digital baseband signals to the BB processing module 402. The RF module 401 includes a portion of the signal reception unit 202 and the signal transmission unit 201 illustrated in FIG. 20, for example.

The BB processing module 402 performs a process of converting an IP packet and a digital baseband signal or vice versa. The DSP 412 is a processor that performs signal processing in the BB processing module 402. A memory 422 is used as a work area of the DSP 412. The BB processing module 402 includes a portion of the signal transmission unit 201, a portion of the signal reception unit 202, and a portion of the notification unit 203 illustrated in FIG. 20, for example.

The device control module 403 performs protocol processing of the IP layer and Operation and Maintenance (OAM) processing. A processor 413 is a processor that performs the processing performed by the device control module 403. A memory 423 is used as a work area of the processor 413. An auxiliary storage device 433 is a HDD, for example, and stores various items of configuration information for the base station eNB itself to operate. The device control module 403 includes a portion of the notification unit 203 illustrated in FIG. 20, for example.

### CONCLUSION

As described above, according to the embodiments, there is provided User equipment of a radio communication system that supports D2D communication, the user equipment including a selector that selects a plurality of control information resources for repeatedly transmitting control information from a control information resource pool and that selects a plurality of data resources for repeatedly transmitting data from a data transmission resource pool; and a transmitter that repeatedly transmits the control information including information that specifies the plurality of data resources using the plurality of control information resources and repeatedly transmits the data using the plurality of data resources, wherein the selector selects the plurality of control information resources and the plurality of data resources so that a control information resource for transmitting the control information for a first time among the plurality of control information resources and a data resource for transmitting the data for a first time among the plurality of data resources are in a same subframe. By this user equipment UE, a technique is provided that allows to execute more appropriate D2D communication when a resource pool configuration is adopted in which a control information resource pool and a data resource pool are frequency-multiplexed.

The selector may select a data resource for transmitting the data for a second time among the plurality of data resources from subframes located between a subframe subsequent to a subframe of the control information resource for transmitting the control information for the first time among the plurality of control information resources and a subframe prior to a subframe of the control information resource for transmitting the control information for a second time. As a result, the reception-side user equipment UE can combine and decode two times of data signals depending on necessity.

The selector may select a data resource for transmitting the data for a second time among the plurality of data resources from subframes which are located on or subsequent to a subframe of the control information resource for transmitting the control information for a second time among the plurality of control information resources. As a result, the reception-side user equipment UE can combine and decode two times of data signals depending on necessity. Additionally, subframes to be buffered by the reception-side user equipment UE can be minimized when the SCI for the first time is not decoded.

The control information resource pool may be split into a plurality of contiguous PSCCH periods, and the selector may select the plurality of control information resources so that the control information resource for transmitting the control information for the first time among the plurality of control information resources and the control information resource for transmitting the control information for a second time are located in different PSCCH periods. As a result, when a resource pool configuration is adopted in which a control information resource pool and a data resource pool are frequency-multiplexed, the SCI resource selection method (hopping pattern) defined in conventional Rel-12 can be applied.

The data transmission resource pool may be split into a plurality of contiguous PSCCH periods, and the selector may select the plurality of data resources so that the data resource for transmitting the data for the first time among the plurality of data resources and the data resource for transmitting the data for a second time are in different PSCCH periods. As a result, when a resource pool configuration is adopted in which a control information resource pool and a data resource pool are frequency-multiplexed, the SCI resource selection method (hopping pattern) defined in conventional Rel-12 can be applied.

The selector may receive, in the control information resource pool, control information transmitted from any other user equipment to determine a reservation state of resources in the control information resource pool and a reservation state of resources in the data transmission resource pool, may select the plurality of control information resources for repeatedly transmitting the control information among the resources which are determined to be vacant in the control information resource pool, and may select the plurality of data resources for repeatedly transmitting the data among the resources which are determined to be vacant in the data transmission resource pool. As a result, the user equipment UE can reduce the possibility that the D2D signal transmitted by itself interferes with a D2D signal transmitted from any other user equipment UE.

The selector may determine a reservation state of resources in the control information resource pool based on a reception power level of each resource in the control information resource pool and may select the plurality of control information resources for repeatedly transmitting the control information among the resources which are determined to be vacant in the control information resource pool, and the selector may determine a reservation state of resources in the data transmission resource pool based on a reception power level of each resource in the data transmission resource pool and may select a plurality of control information resources for repeatedly transmitting the data among the resources which are determined to be vacant in the data transmission resource pool. As a result, the user equipment UE can reduce the possibility that the D2D signal transmitted by itself interferes with a D2D signal transmitted from any other user equipment UE. Additionally, a vacancy state (a reservation state) of resources can be determined based on a reception power level without monitoring SCI, so that the processing load on the user equipment UE can be reduced.

Furthermore, according to the embodiments, there is provided a transmission method executed by user equipment of a radio communication system that supports D2D communication, wherein the transmission method includes selecting a plurality of control information resources for repeatedly transmitting control information from a control information resource pool and selecting a plurality of data resources for repeatedly transmitting data from a data transmission resource pool; and repeatedly transmitting the control information including information that specifies the plurality of data resources using the plurality of control information resources and repeatedly transmitting the data using the plurality of data resources, wherein the selecting selects the plurality of control information resources and the plurality of data resources so that the control information resource for transmitting the control information for a first time among the plurality of control information resources and the data resource for transmitting the data for a first time among the plurality of data resources are in a same subframe. By this transmission method, a technique is provided that allows to execute more appropriate D2D communication when a resource pool configuration is adopted in which a control information resource pool and a data resource pool are frequency-multiplexed.

<Supplementary Explanation According to Embodiment>

The PSCCH period may be referred to as a SA period (Scheduling Assignment Period) or may be referred to as a SC period (Sidelink Control Period).

As described above, the configuration of each device (the user equipment UE/the base station eNB) described in the embodiments of the present invention may be a configuration implemented by executing a program by a CPU (a processor) in the device including the CPU and a memory; may be a configuration implemented by hardware, such as a hardware circuit including a logic for the process described in the embodiments; or a configuration in which a program and hardware coexist.

Notification of information is not limited the aspect/embodiment described in the present specification any may be performed by other methods. For example, notification of information may be performed via physical layer signaling (for example, Downlink Control Information (DCI) or Uplink Control Information (UCI)), upper-layer signaling (for example, RRC signaling, MAC signaling, broadcast information (Master Information Block (MIB), or System Information Block (SIB)), other signals, or by a combination thereof. Moreover, an RRC message may be referred to as the RRC signaling. Furthermore, the RRC message may be an RRC connection setup (RRC Connection Setup) message, a RRC connection reconfiguration (RRC Connection Reconfiguration) message, or the like, for example.

Furthermore, each aspect/embodiment described in this specification can be applied to long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), any other systems using an appropriate system and/or next generation systems expanded on the basis of these systems.

Determination or decision may be made by a value (0 or 1) represented by one bit, may be made by a Boolean value (Boolean: true or false), and may be made by comparison of numerical values (comparison with a predetermined value, for example).

Note that the terms described in this specification and/or the terms necessary for understanding of this specification may be replaced with terms having the same or similar meaning. For example, the channel and/or symbol may be signaling (signal). Furthermore, a signal may be a message.

The UE may be referred to, by a person ordinarily skilled in the art, as a subscriber station, a mobile unit, a subscriber unit, a wireless unit, a remote unit, a mobile device, a wireless device, a wireless communication device, a remote device, a mobile subscriber stations, an access terminal, a mobile terminal, a wireless terminal, a remote terminal, a handset, a user agent, a mobile client, a client, or it may also be called by some other suitable terms.

Each aspect/embodiment described in this specification may be used alone, may be used in combination, or may be used while being switched during the execution. Furthermore, notification of predetermined information (e.g., notification of “being X”) is not limited to notification that is made explicitly, and the notification may be made implicitly (e.g., notification of the predetermined information is not performed).

The terms “determining” and “deciding” used in this specification may include various types of operations. For example, “determining” and “deciding” may include deeming that a result of calculating, computing, processing, deriving, investigating, looking up (e.g., search in a table, a database, or another data structure), or ascertaining is determined or decided. Furthermore, “determining” and “deciding” may include, for example, deeming that a result of receiving (e.g., reception of information), transmitting (e.g., transmission of information), input, output, or accessing (e.g., accessing data in memory) is determined or decided. Furthermore, “determining” and “deciding” may include deeming that a result of resolving, selecting, choosing, establishing, or comparing is determined or decided. Namely, “determining” and “deciding” may include deeming that some operation is determined or decided.

The expression “on the basis of” used in the present specification does not mean “on the basis of only” unless otherwise stated particularly. In other words, the expression “on the basis of” means both “on the basis of only” and “on the basis of at least”.

In addition, processing procedures, sequences, and the like of each aspect/embodiment described in the specification may be exchanged as long as there is no contradiction. For example, for the methods described in the specification, the elements of the various steps are presented in an exemplary order and are not limited to a specific order presented.

Input and output Information and the like may be stored in a specific location (for example, a memory) and may be managed by a management table. The input and output information and the like may be overwritten, updated, or rewritten. The output information and the like may be erased. The input information and the like may be transmitted to other apparatuses.

Notification of predetermined information (e.g., notification of “being X”) is not limited to notification that is made explicitly, and the notification may be made implicitly (e.g., notification of the predetermined information is not performed).

Information, signals, and the like described in the present specification may be represented using any of various other techniques. For example, data, instructions, commands, information, signals, bits, symbols, chips, and the like mentioned in the entire description may be represented by voltage, current, electromagnetic waves, magnetic field or magnetic particles, optical field or photons, or any combination thereof.

While the embodiments of the present invention are described above, the disclosed invention is not limited to such embodiments, and various variations, modifications, alterations, and substitutions may be conceived by those skilled in the art. While specific examples of numerical values are used in order to facilitate understanding of the invention, these numerical values are examples only and any other appropriate values may be used unless otherwise stated particularly. The classification of items in the description is not essential in the present invention, and features described in two or more items may be used in combination, and a feature described in a certain item may be applied to a feature described in another item (provided that they do not contradict). It is not always true that the boundaries of the functional units or the processing units in the functional block diagram correspond to boundaries of physical components. The operations of a plurality of functional units may be physically performed by a single component. Alternatively, the operations of the single functional unit may be physically performed by a plurality of components. The orders in the sequence and the flowchart described in the embodiment may be switched provided that there is no contradiction. For convenience of explanation of processing, the user equipment UE and the base station eNB are described using functional block diagrams. However, these devices may be implemented by hardware, software, or a combination thereof. The software that is operated by a processor included in the user equipment UE according to the embodiment of the present invention and the software that is operated by a processor included in the base station eNB according to the embodiment of the present invention may be stored in a random access memory (RAM), a flash memory, a read only memory (ROM), an EPROM, an EEPROM, a register, a hard disk (HDD), a removable disk, a CD-ROM, a database, a server, and other appropriate storage media.

This international patent application is based upon and claims the benefit of priority of Japanese Patent Application No. 2016-073454 filed on Mar. 31, 2016, and the entire contents of Japanese Patent Application No. 2016-073454 are incorporated herein by reference.

### LIST OF REFERENCE SYMBOLS

UE: User equipment
eNB: Base station
101: Signal transmission unit
102: Signal reception unit
103: Selection unit
201: Signal transmission unit
202: Signal reception unit
203: Notification unit
301: RF module
302: BB processing module
303: UE control module
304: Communication IF
401: RF module
402: BB processing module
403: Device control module

1. User equipment of a radio communication system that supports D2D communication, the user equipment comprising:
a selector that selects a plurality of control information resources for repeatedly transmitting control information from a control information resource pool and that selects a plurality of data resources for repeatedly transmitting data from a data transmission resource pool; and
a transmitter that repeatedly transmits the control information including information that specifies the plurality of data resources using the plurality of control information resources and repeatedly transmits the data using the plurality of data resources,
wherein the selector selects the plurality of control information resources and the plurality of data resources so that a control information resource for transmitting the control information for a first time among the plurality of control information resources and a data resource for transmitting the data for a first time among the plurality of data resources are in a same subframe.

2. The user equipment according to claim 1, wherein the selector selects a data resource for transmitting the data for a second time among the plurality of data resources from subframes located between a subframe subsequent to a subframe of the control information resource for transmitting the control information for the first time among the plurality of control information resources and a subframe prior to a subframe of the control information resource for transmitting the control information for a second time.

3. The user equipment according to claim 1, wherein the selector selects a data resource for transmitting the data for a second time among the plurality of data resources from subframes which are located on or subsequent to a subframe of the control information resource for transmitting the control information for a second time among the plurality of control information resources.

4. The user equipment according to claim 1, wherein the control information resource pool is split into a plurality of contiguous PSCCH periods, and
wherein the selector selects the plurality of control information resources so that the control information resource for transmitting the control information for the first time among the plurality of control information resources and the control information resource for transmitting the control information for a second time are located in different PSCCH periods.

5. The user equipment according to claim 4, wherein the data transmission resource pool is split into a plurality of contiguous PSCCH periods, and
wherein the selector selects the plurality of data resources so that the data resource for transmitting the data for the first time among the plurality of data resources and the data resource for transmitting the data for a second time are in different PSCCH periods.

6. The user equipment according to claim 1, wherein the selector receives, in the control information resource pool, control information transmitted from any other user equipment to determine a reservation state of resources in the control information resource pool and a reservation state of resources in the data transmission resource pool, selects the plurality of control information resources for repeatedly transmitting the control information among the resources which are determined to be vacant in the control information resource pool, and selects the plurality of data resources for repeatedly transmitting the data among the resources which are determined to be vacant in the data transmission resource pool.

7. The user equipment according to claim 1, wherein the selector determines a reservation state of resources in the control information resource pool based on a reception power level of each resource in the control information resource pool and selects the plurality of control information resources for repeatedly transmitting the control information among the resources which are determined to be vacant in the control information resource pool, and
wherein the selector determines a reservation state of resources in the data transmission resource pool based on a reception power level of each resource in the data transmission resource pool and selects a plurality of control information resources for repeatedly transmitting the data among the resources which are determined to be vacant in the data transmission resource pool.

8. A transmission method executed by user equipment of a radio communication system that supports D2D communication, the transmission method comprising:
selecting a plurality of control information resources for repeatedly transmitting control information from a control information resource pool and selecting a plurality of data resources for repeatedly transmitting data from a data transmission resource pool; and
repeatedly transmitting the control information including information that specifies the plurality of data resources using the plurality of control information resources and repeatedly transmitting the data using the plurality of data resources,
wherein the selecting selects the plurality of control information resources and the plurality of data resources so that the control information resource for transmitting the control information for a first time among the plurality of control information resources and the data resource for transmitting the data for a first time among the plurality of data resources are in a same subframe.
